(19) United States
(12) Patent Application Publication
(10) Pub. No.: US 2010/0246915 A1
(43) Pub. Date: Sep. 30, 2010

(54) PATIENT REGISTRATION SYSTEM

(75) Inventors: Ryoichi Yamakoshi, Tokyo (JP); Kosuke Hirasawa, Tokyo (JP); Haruhisa Okuda, Tokyo (JP); Hiroshi Kage, Tokyo (JP); Kazuhiko Sumi, Tokyo (JP); Hidenobu Sakamoto, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/683,584

(22) Filed: Jan. 7, 2010

(30) Foreign Application Priority Data
Mar. 27, 2009 (JP) 2009-079275
Aug. 10, 2009 (JP) 2009-185607

(51) Int. Cl. G06K 9/62; H05G 1/60

(52) U.S. Cl. 382/131; 378/4

(57) ABSTRACT

There is provided a patient registration system according to the present invention, including: a CT data capturing device; an X-ray television imaging device; and an image processing device for generating a two-dimensional DRR image based on the captured CT data, and then calculating an amount of displacement between a first diseased site position when the CT data is captured and a second diseased site position when the X-ray television image is captured. The image processing device carries out processes of: three-dimensional analysis for extracting an amount of three-dimensional characteristic from the three-dimensional CT data; two-dimensional analysis for extracting an amount of two-dimensional characteristic from both of the DRR image and the X-ray television image; characteristic evaluation for evaluating the extracted characteristic amounts; area limitation for selecting an area where the evaluated characteristic amounts are present; and displacement estimation for estimating an amount of displacement between the first diseased site position and the second diseased site position within the selected area, whereby achieving quick and accurate registration of patient.

### BACKGROUND OF THE INVENTION

1. Field of the Invention

The present invention relates to a patient registration system which is suitably used for radiotherapy in which a nidus of a patient can be treated by irradiating the nidus with a radiation beam or a particle beam.

2. Description of the Related Art

A typical patient registration system initially receives 3-D (three-dimensional) CT (Computed Tomography) data for planning of treatment, which can be captured by scanning a nidus of a patient using a tomographic equipment, such as X-ray CT scanner. Planning of treatment can be developed based on diagnostic results of the CT data. At this time, positions and shapes of tumor sites are identified based on the 3-D CT data to determine irradiating directions and doses of radiation.

Next, radiotherapy will be carried out according to the determined plan of treatment. However, in a case in which a long period of time has elapsed from the CT scanning to the radiotherapy, a position and a body posture of the patient lying on a treatment table during treatment are often different from these of the patient during planning of treatment. Accordingly, prior to carrying out radiotherapy, it is necessary to correct displacement between the current position of the patient and the previous position of the patient during planning of treatment.

A reference image required for calculating an amount of displacement correction can be reconstructed based on the 3-D data for planning of treatment to generate a reference DRR (Digitally Reconstructed Radiograph) image. On the other hand, the current position of patient can be captured using an X-ray television imaging device. Thus, the captured X-ray television image and the reconstructed DRR image are compared and image-processed to calculate the amount of correction. Then, the 3-D position and posture of the treatment table are adjusted based on the calculated amount of correction so that a treatment beam is directed to an appropriate position of a diseased site. Such above-mentioned processes are performed in the patient registration system, in which improved accuracy and speed of patient registration are still required.

In recent radiotherapy, using a particle beam, for example, a dose of radiation can be concentrated within a body of patient. Also, by adjusting energy of the treatment beam with respect to a depth position of a tumor, it is possible to align a high dose portion with the tumor site. In other words, a high dose can be delivered only to the tumor while reducing an influence to normal tissue around the tumor. In order to take advantage of this characteristic, highly accurate patient registration techniques for irradiating only the tumor site with the particle beam are important.

In an existing patient registration system, body markers, i.e., indicators of registration, are embedded within a body of patient in advance, and then CT data including three-dimensional position information of a tumor and the markers is captured using a tomographic equipment. Then, planning of treatment is developed with the markers being still embedded.

During treatment, an image reconstructed based on the CT data used for planning of treatment is generated. Then, using an X-ray television imaging diagnostic device, an X-ray television image including three-dimensional positions of the tumor and the markers are projected, thus identifying the current position and posture of the patient.

The patient registration is carried out by overlaying the actual positions of the body markers and the positions of the markers for planning on these two images, i.e., the DRR image and the X-ray television image. Pattern matching between images is used for such a registration technique.

According to the above existing technique, however, the markers acting as indicators for registration may form blind spots in the X-ray television image captured using an X-ray television imaging device. The following Patent Publication 1 discloses an attempt to address such a problem. The Patent Publication 2 proposes usage of body markers to ensure a sufficient accuracy in patient registration. Moreover, The following Literature 6 proposes a technique of patient registration without using any body markers.

Further, the Patent Publication 6 discloses that patient registration can be automatically carried out by initially setting up characteristic points designated by a user, and then detecting the characteristic points afterward.

The related prior arts are listed as follows: Japanese Patent Unexamined Publications (koukai) (1) JP-2000-140137A, (2) JP-2006-218315A, (3) JP-2007-282877A, (4) JP-10-21393A (1998), (5) JP-3360469B, (6) JP-2008-228966A and Literatures (7) “A GPGPU Approach for Accelerating 2-D/3-D Rigid Registration of Medical Images” (LECTURE NOTES IN COMPUTER SCIENCE 2006, NUMB 4330, pages 939-950), and (8) “Improvement of depth position in 2-D/3-D registration of knee implants using single-plane fluoroscopy” (Medical Imaging, IEEE Transactions, May 2004, Vol. 23, Issue 5, pp. 602-612).

In Patent Publications 1 and 2, registration is carried out using a characteristic such as body markers. However, embedding body markers in a body of patient will cause not only a problem of invasiveness to the body but also another problem of displacement of the body markers after a long period of time has elapsed from CT scanning to radiotherapy. Moreover, in some cases, it is not possible to embed the markers in the body of patient depending on conditions of the diseased site.

In Literature 7, an amount of displacement between a DRR image and an X-ray television image can be calculated using normalized correlation between edge features of the DRR image and edge features of the X-ray television image, without any body markers acting as a landmark. This approach can calculate a rotation on a two-dimensional imaging plane, but it is difficult to calculate a rotation outside the imaging plane as an amount of three-dimensional correction.

### SUMMARY OF THE INVENTION

It is an object of the present invention is to provide a patient registration system which can adequately estimate an amount of displacement not only on an imaging plane but also outside the imaging plane by analyzing in advance both of CT data and a DRR image during DRR image generation process, thereby achieving registration of patient in a short time and with high accuracy.

In order to achieve the above object, according to an aspect of the present invention, there is provided a patient registration system including:

a CT data capturing device for capturing three-dimensional CT data of a diseased site;

an X-ray television imaging device for capturing an X-ray television image of the diseased site; and

an image processing device for generating a two-dimensional DRR image based on the captured CT data, and then calculating an amount of displacement between a first diseased site position when the CT data is captured and a second diseased site position when the X-ray television image is captured, based on the generated DRR image and the captured X-ray television image;

wherein the image processing device carries out processes of:

three-dimensional analysis for extracting an amount of three-dimensional characteristic from the three-dimensional CT data;

two-dimensional analysis for extracting an amount of two-dimensional characteristic from both of the DRR image and the X-ray television image;

characteristic evaluation for evaluating the extracted characteristic amounts;

area limitation for selecting an area where the evaluated characteristic amounts are present; and

displacement estimation for estimating an amount of displacement between the first diseased site position and the second diseased site position within the selected area.

It is preferable that the image processing device carries out data compression of the captured three-dimensional CT data to convert them into low resolution three-dimensional CT data.

According to another aspect of the present invention, there is also provided a patient registration system including:

a CT data capturing device for capturing three-dimensional CT data of a diseased site;

an X-ray television imaging device for capturing an X-ray television image of the diseased site; and

an image processing device for generating a two-dimensional DRR image based on the captured CT data, and then calculating an amount of displacement between a first diseased site position when the CT data is captured and a second diseased site position when the X-ray television image is captured, based on the generated DRR image and the captured X-ray television image;

wherein the image processing device carries out processes of:

two-dimensional analysis for extracting an amount of two-dimensional characteristic from both of the DRR image and the X-ray television image;

characteristic evaluation for evaluating the extracted characteristic amounts;

area limitation for selecting an area where the evaluated characteristic amounts are present; and

displacement estimation for estimating an amount of displacement between the first diseased site position and the second diseased site position within the selected area; and

optimum parameter estimation for estimating an optimum parameter by varying a parameter of out-of-plane rotation after the displacement estimation.

It is preferable that the image processing device carries out a process of optimum parameter estimation for estimating an optimum parameter by varying a parameter of out-of-plane rotation after the displacement estimation.

It is preferable that when estimating an optimum parameter by varying a parameter of out-of-plane rotation, the image processing device evaluates whether or not the characteristic point disappears.

It is preferable that in the displacement estimation, the image processing device firstly estimates the amount of displacement of the area that is distant from the isocenter when the X-ray television image is captured, and then estimates the amount of displacement of the area that is closer to the isocenter.

It is preferable that in the two-dimensional analysis, the processing is carried out by limiting only to the CT data having brightness values within a predetermined range.

It is preferable that the image processing device evaluates preservability expressing a possibility that a characteristic point in the three-dimensional CT data can be preserved in the two-dimensional DRR image to generate a projected image, and then extracts a characteristic point which has preservability or is matched between the projected image of an area and the X-ray television image to carry out three-dimensional registration based on the extracted characteristic point.

It is preferable that the image processing device displays the result of evaluation of preservability on the two-dimensional DRR image.

It is preferable that the image processing device extracts a characteristic point using anatomic information.

It is preferable that the image processing device extracts a characteristic point which can be largely shifted on the two-dimensional DRR image during movement of coordinates.

According to another aspect of the present invention, there is provided a patient registration system including:

a CT data capturing device for capturing three-dimensional CT data of a diseased site;

an X-ray television imaging device for capturing an X-ray television image of the diseased site; and

an image processing device for generating a two-dimensional DRR image based on the captured CT data, and then calculating an amount of displacement between a first diseased site position when the CT data is captured and a second diseased site position when the X-ray television image is captured, based on the generated DRR image and the captured X-ray television image;

wherein the image processing device carries out processes of:

three-dimensional analysis for extracting an amount of three-dimensional characteristic from the three-dimensional CT data;

two-dimensional analysis for extracting an amount of two-dimensional characteristic from both of the DRR image and the X-ray television image;

characteristic evaluation for evaluating the extracted characteristic amounts;

characteristic stability evaluation for evaluating preservability expressing a possibility that a characteristic point in the three-dimensional CT data can be preserved in the two-dimensional DRR image; and

displacement estimation for estimating an amount of displacement between the first diseased site position and the second diseased site position based on the plural characteristic points having preservability.

It is preferable that the image processing device applies statistical processing to the result of patient registration to store them as treatment plan data.

According to an embodiment of the present invention, by carrying out the processes of extraction of the three-dimensional characteristic, characteristic evaluation and area limitation, an amount of displacement not only on an imaging plane but also outside the imaging plane can be adequately estimated during patient registration. Further, the amount of displacement can be estimated within the area of interest, thereby achieving registration of patient in a short time and with high accuracy.

### BRIEF DESCRIPTION OF THE DRAWINGS

FIG. 1 shows a configurational view illustrating a patient registration system according to Embodiment 1 of the present invention;

FIG. 2 shows a block diagram illustrating a configuration of a patient registration image processing device;

FIG. 3 shows an explanatory view illustrating how 3-D CT data is captured by a tomographic device;

FIG. 4 shows an explanatory view illustrating how an X-ray television image of a patient is captured;

FIG. 5 shows an explanatory view illustrating a technique of generating a DRR image using ray casting algorithm;

FIG. 6 shows a process flowchart illustrating an operation of a patient registration image processing device;

FIG. 7 shows an explanatory view illustrating processing of compressing (layering) a two-dimensional image;

FIG. 8 shows an explanatory view illustrating processing of compressing (layering) three-dimensional volume data;

FIG. 9 shows an explanatory view illustrating processing of limiting an extraction area from a CT image;

FIG. 10 shows an explanatory view illustrating a process of ray casting only to the limited area;

FIG. 11 shows an explanatory view illustrating overlapping characteristic points in ray casting algorithm;

FIG. 12 shows an explanatory view illustrating additive terms in ray casting algorithm;

FIG. 13 shows a process flowchart illustrating another operation of a patient registration image processing device; and

FIG. 14 shows a process flowchart illustrating yet another operation of a patient registration image processing device.

### DETAILED DESCRIPTION OF THE PREFERRED EMBODIMENTS

This application is based on an application No. 2009-79275 filed on Mar. 27, 2009 in Japan, the disclosure of which is incorporated herein by reference.

Hereinafter, preferred embodiments will be described with reference to drawings.

### Embodiment 1

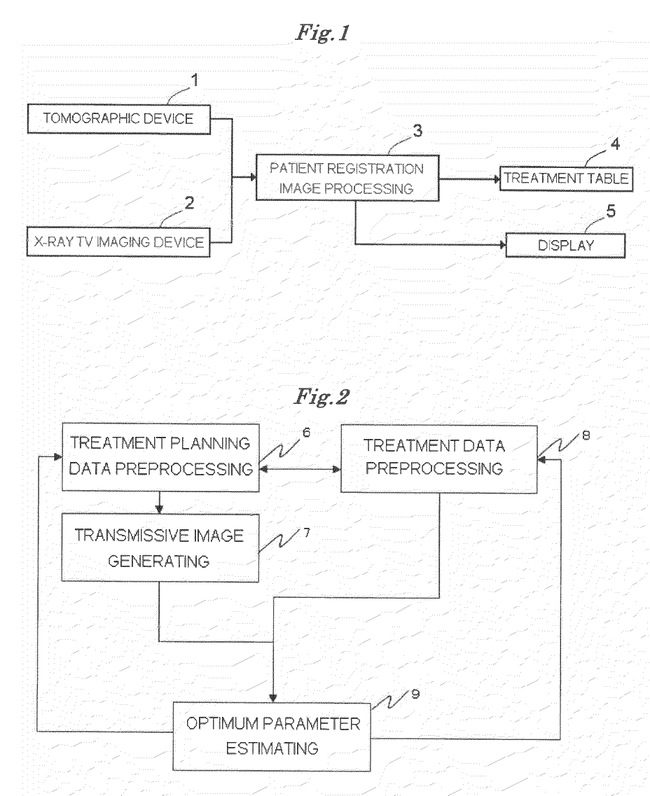

FIG. 1 shows a configurational view illustrating a patient registration system according to a first embodiment of the present invention. The patient registration system is configured of a tomographic device 1, an X-ray television imaging device 2, a patient registration image processing device 3, a treatment table 4, a display device 5, and an input device (not shown) such as keyboard, mouse and the like.

The tomographic device 1 is configured of, for example, an X-ray CT (Computed Tomography) scanner, and serves a function of capturing 3-D (three-dimensional) CT data of a diseased site. The X-ray television imaging device 2 is configured of, for example, an X-ray image intensifier tube, and serves a function of capturing an X-ray television image of the diseased site. The X-ray television imaging device 2 is usually installed integrally with a radiotherapy equipment.

The patient registration image processing device 3 can be configured of one or more computers and the like, and generates a 2-D (two-dimensional) DRR (Digitally Reconstructed Radiograph) image based on the CT data captured by the tomographic device 1, and then calculates an amount of displacement between a first diseased site position when the CT data is captured and a second diseased site position when the X-ray television image is captured, based on the generated DRR image and the X-ray television image captured by the X-ray television imaging device 2.

The treatment table 4 is provided with a mechanism which can adjust the three-dimensional position and posture of a patient so that an appropriate position of a diseased site can be irradiated with a treatment beam, such as radiation beam or particle beam, during radiotherapy. The display device 5 can display the 3-D CT data and the X-ray television image, as well as results processed by the patient registration image processing device 3.

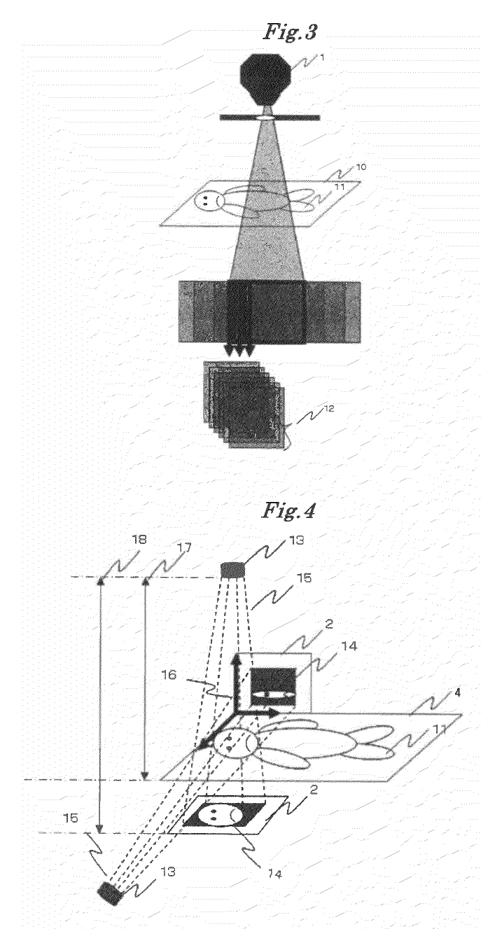

A process flow from planning of treatment for a patient to actual radiotherapy will be described below. First, in order to develop a treatment plan, as shown in FIG. 3, while a patient 11 is lying on an imaging table 10, the 3-D CT data 12 of the patient 11 is captured as three-dimensional data for planning of treatment using the tomographic device 1. Then, a treatment plan is developed based on diagnostic results of the CT data.

After development of the treatment plan, radiotherapy is started. At this time, in order to determine the position of the patient during treatment, as shown in FIG. 4, while the patient 11 is lying on the treatment table 4 of the radiotherapy equipment, an X-ray tube 13 radiates an X-ray 15 to capture an X-ray television image 14 using the X-ray television imaging device 2. Three-dimensional position information of the patient can be obtained by capturing a plurality of X-ray television images 14 in different directions.

Incidentally, in FIG. 4, a reference numeral 16 denotes reference coordinates of a treatment room, a reference numeral 17 denotes a distance between the X-ray tube 13 and a radiation center (isocenter) of the X-ray 15, and a reference numeral 18 denotes a distance between the X-ray tube 13 and the X-ray television imaging device 2.

Thereafter, the patient registration image processing device 3 can calculate an amount of displacement between the current position of patient and the previous position thereof during planning of treatment, based on the data captured by both of the tomographic device 1 and the X-ray television imaging device 2. The current position of patient can be aligned with the previous position during planning of treatment by adjusting the three-dimensional position and posture of the treatment table 4 based on the calculated amount of displacement.

In order to confirm whether the current position of patient is correct, the X-ray television image 14 is captured again using the X-ray television imaging device 2 to display it on the display device 5. It can be confirm that the amount of displacement between the images is equal to or smaller than a predetermined value by overlaying of the X-ray television image 14 and a DRR image 20.

FIG. 2 shows a block diagram illustrating a configuration of the patient registration image processing device 3. The image processing device 3 includes a treatment planning data preprocessing device 6, a transmissive image generating device 7, a treatment data preprocessing device 8, and an optimum parameter estimating device 9.

The treatment planning data preprocessing device 6 carries out various image processing to input data, i.e., the 3-D CT data 12 captured by the tomographic device 1. The transmissive image generating device 7 reconstructs the 3-D CT data 12 processed by the device 6 to generate a DRR image. The treatment data preprocessing device 8 carries out various image processing to input data, i.e., the X-ray television image 14 representing the current position of patient. The optimum parameter estimating device 9 calculates the amount of displacement between the first diseased site position when the CT data is captured and the second diseased site position when the X-ray television image is captured, based on the generated DRR image and the X-ray television image 14. Thus, the three-dimensional position and posture of the treatment table 4 can be adjusted based on the calculated amount of displacement.

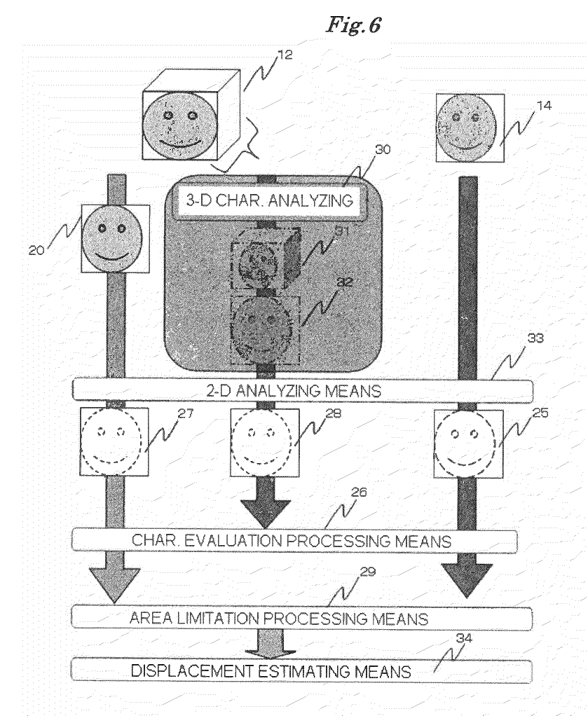

FIG. 6 shows a process flowchart illustrating an operation of the patient registration image processing device 3. The patient registration image processing device 3 first obtains the CT data 12 and the X-ray television image 14 as described above.

Next, although not shown in FIG. 6, the device 3 obtains irradiation parameters, such as a target center (isocenter) of the X-ray television imaging device 2 and irradiation directions of the treatment beam, which are used during treatment. The parameters obtained by this processing also include a three-dimensional position of the target center (isocenter) of radiotherapy, the distance 17 between the X-ray tube 13 and the target center (isocenter) of radiotherapy, as well as a focal length 18 (of treatment beam) between the X-ray tube 15 and the X-ray television imaging device 2, and the treatment room coordinates 16, expressing geometric position information in the treatment room (FIG. 4). These parameters are also necessary to generate the same image from the 3-D CT data 12 as the X-ray television image 14 captured by the X-ray television imaging device 2. The processing as described above is carried out by the treatment planning data preprocessing device 6 and the treatment data preprocessing device 8.

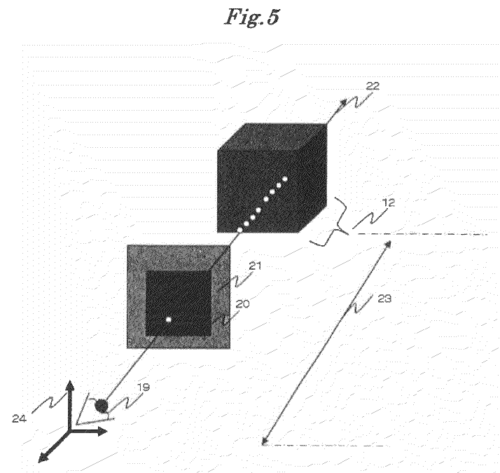

Next, the DRR image is generated using parameters such as the treatment room coordinates 16. The generation is carried out using, for example, ray casting algorithm. In the ray casting algorithm, as shown in FIG. 5, a light beam 22 that passes through a point of view (POV) 19 and the volume data with respect to volume data (the CT data 12 herein) is assumed. Then, densities of voxels (brightness values) located on the light beam 22 are summed, thereby generating the DRR image 20 from a semi-transparent transmissive image plane 21 based on the resultant total brightness values. In FIG. 5, a reference numeral 23 denotes a distance between the point of view for generating the DRR image and an object, and a reference numeral 24 denotes coordinates where the DRR image is generated. A reference numeral 20 in FIG. 6 denotes a result of generation of the DRR image using known parameters. The processing as described above is carried out by the transmissive image generating device 7.

Next, a three-dimensional characteristic of the CT data 12 is analyzed using a three-dimensional characteristic analyzing means 30 in FIG. 6. This processing is carried out by the treatment planning data preprocessing device 6. Concrete examples of techniques for analyzing the three-dimensional characteristic include the followings. In this embodiment, any of the characteristic amounts listed below can be employed.

First, as a basic characteristic amount, brightness values of a volume of interest, an average brightness within an area (gate size), an average brightness square sum within the area, dispersion within the area, standard deviation within the area, a square sum of occurrence probability, entropy using occurrence probability, or the like can be employed.

Further, as another characteristic amount, one or more of the following characteristic amounts can be employed: a characteristic amount obtained by dividing the CT data 12 into blocks and analyzing dispersion such as an orientation of a normal vector of an apex for each block; a characteristic amount using a curvature which is an amount representing a degree of curve of a curved surface that is previously prepared; a characteristic amount using the brightness value of the CT data of a surface profile which can be obtained using a marching cube and the like; a characteristic amount obtained using a spin image and the like by determining two arbitrary points of view; a characteristic amount using local binary pattern that is a texture pattern or Cubic Higher-order Local Auto-Correlation; a method of using three-dimensionally extended SHIFT (Scale Invariant Feature Transform); a characteristic amount obtained by obtaining eigenvalues of the three-dimensional volume data in each of three axial directions and evaluating a shape of an internal tissue based on the eigenvalues; a characteristic amount simply using values of the CT image itself; a characteristic amount obtained using three-dimensional Hough transform; a characteristic of a three-dimensional ART filter; a characteristic amount of three-dimensional brightness histogram of oriented gradients; a characteristic amount obtained using a 3D Gaussian filter; a characteristic obtained using a 3D FFT filter; and finally, a characteristic amount as the most suitable combination of characteristic amounts selected by combining the characteristic amounts listed above and evaluating the combinations.

Moreover, in some cases, it may be difficult to evaluate the characteristic amount because the CT data has a small variation in brightness value. Accordingly, it is preferable to use characteristics that are emphasized by compressing the CT data, as shown in FIG. 8. These characteristic amounts are also available to analyze the characteristics of the three-dimensional data. For example, it is advantageously possible to conduct a three-dimensional analysis of characteristics existing around the tumor, such as portions where bone density (brightness) is higher or lower. Alternatively, anatomic information may be used. The result of the processing corresponds to three-dimensional characteristic analysis data 31. Then, a DRR image 32 is generated based on the processing result 31. In this process of DRR generation, the DRR image 20 is generated from the CT data 12 without the three-dimensional characteristic analysis, and the DRR image 32 is generated by using the characteristic amount obtained afterward by the three-dimensional characteristic analyzing means and by storing values and three-dimensional positions of pixels on the transmissive plane, which can be obtained along a direction of a line of sight of the light beam 22 passing through. Alternatively, the DRR image 32 may be also generated using the area of the characteristic itself obtained using the characteristic analysis result 31.

A two-dimensional analyzing means 33 carries out filtering to the DRR image 20, the DRR image 32 generated based on the characteristic analysis result, and the X-ray television image 14 using a filter, such as a Canny operator, a Harris Corner Detector, a Good Features, or the like. Alternatively, the characteristic extraction by the three-dimensional characteristic analyzing means may be used for two-dimensional processing. In FIG. 6, a DRR processing result image 27, a DRR image 28 to which a three-dimensional analysis is carried out, and an X-ray television processing result image 25 represent the processing results. However, the two-dimensional analyzing means 33 may not use the same filter for all of the images. In other words, different filters may be used for the DRR image 20 and the DRR image 32 generated based on the characteristic analysis results, depending on the images. This processing is carried out by the treatment plan data preprocessing device 8.

A characteristic evaluation processing means 26 evaluates whether or not the three-dimensional characteristic is retained between the DRR image processing result image 27 and the DRR image processing image 28 generated based on the three-dimensional analysis. As the evaluation method, the characteristic amount is evaluated at or around the portion where pixel values of the both images are coincident with each other. As evaluation techniques, a correlation within an area, a mutual information content, or a matching point by a raster operation may be used. Further, although not shown in FIG. 6, evaluation may be done by feeding back the filter used by the three-dimensional analyzing means so as to increase a number of matching areas and pixel values. For example, using a neural network, SVM or Boosting, and an identification technique using a stochastic model, a combination of optimum filters may be learned in advance by this feedback processing. Alternatively, out-of-plane rotation is carried out by a known amount, and then a plurality of DRR images can be successively generated. Then, changes in the characteristic amount among the plurality of images are evaluated, or a filter that is effective for the out-of-plane rotation is evaluated by learning of the feedback processing. As the evaluation image used in the feedback, not only the DRR image processing image 28 generated by the three-dimensional analysis, but also the X-ray television processing result image 25 may be used. In this case, the X-ray television processing result image 25 and the DRR image processing result image 27 are required to have been generated using the same conditions of parameters and the patient position. This processing is carried out by the treatment planning data preprocessing device 6 and the treatment data preprocessing device 8.

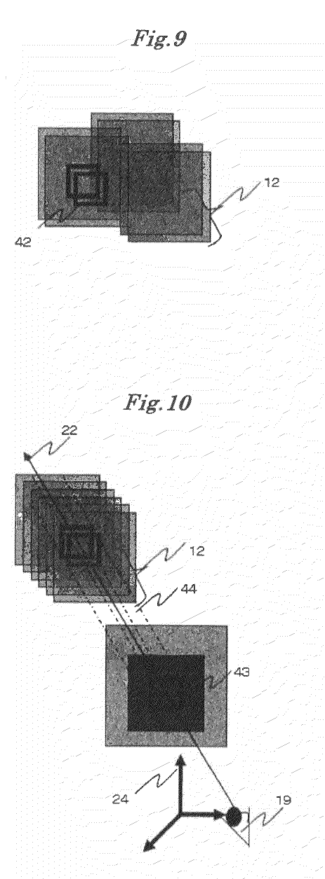

An area limitation processing means 29 limits only an area of the result obtained by the three-dimensional characteristic analyzing means 30 and the two-dimensional analyzing means 33. In other words, as shown in FIG. 9, only an extraction area is extracted from the CT image 12 and limited. Then, ray casting processing, as shown in FIG. 10, is carried out using only a limited area 42. As a result, calculation cost can be reduced.

Further, in the area limitation 42 shown in FIG. 10, either an area that is slightly larger than an area of a tumor site identified by a doctor, or an outline information that is identified as a tumor may be specified. With this processing, it is advantageous that calculation cost and convergence of parameter estimation in displacement estimation 34 can be further improved. In FIG. 10, a reference numeral 43 denotes a DRR image generated using only a limited area, i.e., a volume area in which the light beam 22 passes through the limited area. This processing is carried out by the treatment planning data preprocessing device 6.

A displacement estimating means 34 carries out template matching, as described in Patent Publication 5. Alternatively, the displacement estimating means 34 carries out an evaluation using simple pixel to pixel comparison and estimates optimum parameters. In other words, the displacement estimating means 34 carries out position matching between the position of the CT data 12 in the DRR image coordinates 24 and the patient's position in the treatment coordinates 16 using the DRR image 20 and the X-ray television image 14. Alternatively, the evaluation may be carried out using mutual information content as an evaluation value. As the estimation method, a commonly used optimization technique such as a conjugate gradient method or annealing is used. Alternatively, instead of obtaining the characteristic amount based on the pixel values of the image, it is possible to use a technique such that the volume data (CT data 12) in three-dimensional DCT is subjected to integration calculation as it is by ray casting, and a transmissive characteristic space different from the DRR image 20 is generated. Thereafter, the image captured by the X-ray television image 14 is subjected to DCT transform (discrete cosine transform), and the optimum parameter estimate means 31 may be taken using the obtained characteristic amount. In this manner, it is possible to carry out noise resistant parameter estimation, thereby reducing the calculation cost. Alternatively, the displacement estimation can be carried out using a plurality of filters. This processing is carried out by the optimum parameter estimating device 9.

Further, although not shown in the drawings, in output of registration, a shift (displacement) of three-dimensional translation and rotation parameters obtained by the displacement estimating means 34 can be reflected to irradiation conditions of the radiation beam, and then the DRR image 20 is regenerated and the same evaluation is repeated. The amount of displacement is calculated on the computer until it ultimately becomes smaller than an arbitrarily set threshold value, and then the processing is terminated. The DRR image 20 and the X-ray television image 14 reflecting the obtained amount of displacement are outputted to the display device 5, and the amount of displacement is reflected to the treatment table 4. This processing is carried out by the patient positioning image processing device 3.

By carrying out the above described processing, it is possible to efficiently estimate the amount of displacement in the three-dimensional position.

### Embodiment 2

In this embodiment, in the process flow shown in FIG. 6 of Embodiment 1, the data is compressed to calculate the amount of displacement. This processing compresses the data without damaging the three-dimensional characteristic of the CT data 12. Then, registration is carried out using the compressed data. For this method of compression without damaging the three-dimensional characteristic, the three-dimensional characteristic analyzing means 30 is used.

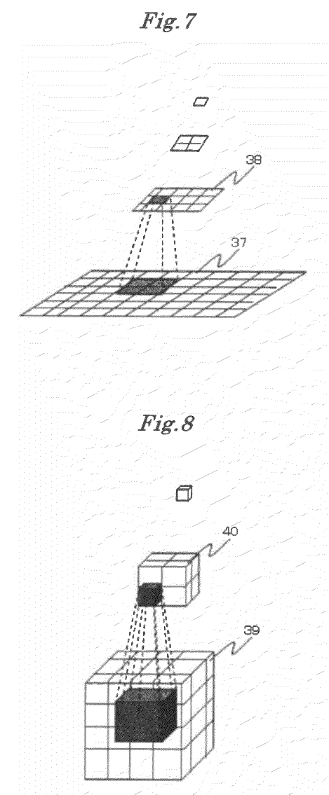

This method is carried out, as described in Patent Publication 4, by expanding the processing of the two-dimensional image as shown in FIG. 7 to the three-dimensional volume data as shown in FIG. 8. First, the whole CT data 12 is divided into blocks, and then compressed using high resolution volume data 39 and low resolution volume data 40 that are areas before and after compressing the divided area, without damaging the three-dimensional characteristic. Alternatively, the CT data 12 may be compressed without carrying out the three-dimensional characteristic analysis 30.

The compression rate here is evaluated by such a method of using a stochastic model (mutual information content) or a method of simply averaging the characteristic amounts, as the number of voxels in high resolution and low resolution are different for the data before compression (the high resolution volume data 39) and the data after compression (the low resolution volume data 40).

Then, the compression rate of the data is determined using a predetermined threshold value. Here, the compression rate may be previously and arbitrarily specified by a user during treatment. With this analysis, it is advantageously possible to retain the characteristic of the three-dimensional data before and after the compression of the CT data 12. By selecting the filtering to be used in the three-dimensional characteristic analysis, it is possible to select an arbitrary characteristic in the data compression, for example, the characteristic amount without damaging bone and tumor site.

Here, FIG. 7 schematically shows the data compression by layering the image. In other words, FIG. 7 shows that a high resolution image 37 is compressed to a low resolution image 38. Similarly, FIG. 8 shows that the high resolution volume data 39 is compressed to the low resolution volume data 40. The data layering is carried out for each voxel in the vicinity based on the compression rate obtained here. This processing may be such that after carrying out the processing and compression using three-dimensional DCT transform in a frequency region, inverse DCT transform is carried out. With this processing, it is possible to reduce the data and to remove an influence of the noise. Further, the X-ray television image 14 is compressed so that the size of the X-ray television image 14 becomes the same as that of the DRR image 20. This processing is carried out by the patient registration image processing device 3.

By carrying out the data compression as described above, it is possible to reduce cost for calculating displacement.

### Embodiment 3

In this embodiment, in the process flow shown in FIG. 6 of Embodiment 1, the displacement estimation is carried out using only the characteristic amount obtained by the characteristic evaluation processing means 26, without using the three-dimensional characteristic analyzing means 30, the characteristic evaluation processing means 26, and the area limitation processing means 29. After convergence, the amount of displacement is varied as the parameter for out-of-plane rotation.

The parameter is varied by the following method. In a generation method here, the parameters are varied at random (Mersenne twister or the like). Alternatively, the parameters are varied by changing a varying range of parameter at an arbitrary step such as (+5 degrees to −5 degrees) with respect to an out-of-plane rotation axis. In this case, limiting values of the varying range is maximum values of movement of the treatment table corresponding to the out-of-plane rotation. Alternatively, the parameter is set to a parameter for the out-of-plane rotation corresponding to a range within which a target site shown in the X-ray television image is supposed to be moved. The step width is determined based on the resolution of the image. In other words, since a width between pixels of the obtained X-ray television image is the limiting value of the estimated amount of displacement, the step width can be determined at an accuracy corresponding thereto. Alternatively, a value of a step width used in a conjugate gradient method used in the parameter estimation may be used as it is. Alternatively, by arbitrarily changing the parameter for out-of-plane rotation, the correlation (cross-correlation or mutual information content) between the DRR image before rotation (or the X-ray television image captured in known coordinates) and the DRR image or the X-ray television image subjected to the out-of-plane rotation is obtained, thereby plotting a curve of errors. The evaluation of the two-dimensional characteristic filter is carried out in that the plotted curve becomes acute. For example, in the evaluation method, used is a filter with which the curve shows a change such that there is only a single minimal solution. Alternatively, a filter that is changed according to an amount of change of the curve (such as first derivation and second derivation) is selected. Here, as the evaluation of the curve largely differ depending on an interval to plot the curve, the step width is set randomly, or determined taking the image resolution in account.

Then, as a displacement estimation parameter, a flow detection is carried out based on concentration gradient between the images and the estimation is carried out between adjacent angular components. The evaluation is carried out by a gradient method, for example to estimate the optimum parameter. In this processing, the evaluation of the out-of-plane rotation is carried out after estimation of displacement, and an actual degree of matching is evaluated.

### Embodiment 4

In this embodiment, the technique according to Embodiment 3 is expanded as follows. First, the displacement estimating means 34 in the process flow according to Embodiment 1 carries out the following processing. In convergence process in displacement estimation, it is evaluated every time whether characteristic point and area obtained by the characteristic evaluation processing means 26 are present or not. The evaluation method here carries out tracking and the like, for example, and evaluates whether or not the characteristic point or the characteristic area disappears due to the out-of-plane rotation. Alternatively, the two-dimensional analyzing means 33 and the characteristic amount analyzing means 26 operate every time to evaluate the number of the characteristic amount. Then, when the characteristic point and area of interest (the characteristic area near the isocenter and the characteristic area away from the isocenter) disappear in the convergence process, the following processing is carried out. Here, the tracking is commonly known condensation and the like using KLT or a stochastic model.

As a displacement estimation parameter, by carrying out a flow detection based on the concentration gradient between the images or the evaluation between adjacent angular components, a parameter of the out-of-plane rotation is varied. Alternatively, like annealing, as a displacement estimation parameter, a parameter of the out-of-plane rotation is varied. Then, a correlation value is derived in the non-disappearing characteristic area with respect to the evaluation, and the parameter value varying for the out-of-plane rotation is reflected to the displacement amount estimation. Alternatively, the non-disappearing characteristic area distant from the point of origin of the coordinates of the translation and rotation is evaluated. In other words, the characteristic area that is closer to the point of origin of the translation and rotation coordinates has a greater influence on the out-of-plane rotation than the characteristic area that is distant from the point of origin of the translation and rotation coordinates. Accordingly, the evaluation is carried out using the characteristic area that is distant from the point of origin of the translation and rotation coordinates. Alternatively, the evaluation may be carried out by weighting the characteristic area that is distant from the point of origin of the translation and rotation coordinates to the characteristic area that is closer to the point of origin of the translation and rotation coordinates. With this processing, it is possible to realize the estimation resistant to the out-of-plane rotation.

### Embodiment 5

In this embodiment, in the generation of the DRR image 20 according to Embodiments 1 to 3, the DRR image 20 is generated using the brightness value of the arbitrary CT data 12. Generally, when using ray casting algorithm, a CT value is between −1000 and 1000. However, a CT value of actual bone or the like is about 400. Accordingly, when generating the DRR image, the processing is carried out by limiting only to the CT data having brightness values within a predetermined range. As a result, it is possible to obtain an image in which a bone or the like is emphasized by limiting to, for example, the DRR of the CT value around 400, i.e., the CT data of brightness values from 390 to 410. This corresponds to a result of edge filtering to the whole DRR including the CT values of an entire range from −1000 to 1000. This processing can realize the same effect as an edge treatment carried out by the two-dimensional analyzing means 33.

### Embodiment 6

In this embodiment, the following processing is carried out in a stepwise manner instead of estimating the amount of displacement while changing the resolution of the three-dimensional volume data according to Embodiment 2.

As to the limited characteristic area according to Embodiment 4, the area distant from the point of origin of the coordinates of the translation and rotation is first evaluated. Then, the area that is gradually closer to the point of origin is stepwise evaluated. Alternatively, the attention is first given only to the area that is distant from the point of origin, and then gradually the entire limited area is evaluated. In this manner, the amount of calculation can be reduced, and the positioning accuracy can be improved since it is possible to avoid a local solution. In addition, it is also possible to reduce the amount of calculation since the generation of the low resolution data is not necessary.

### Embodiment 7

This embodiment is implemented by combining both of the technique according to Embodiment 1 and the technique according to Embodiment 2. Specifically, rough registration is first carried out based on the compressed low resolution data, and then, by enhancing the resolution, the displacement amount is estimated in detail. This is advantageous in that it is possible to avoid a local solution in the estimation of the displacement amount and improve the registration accuracy.

### Embodiment 8

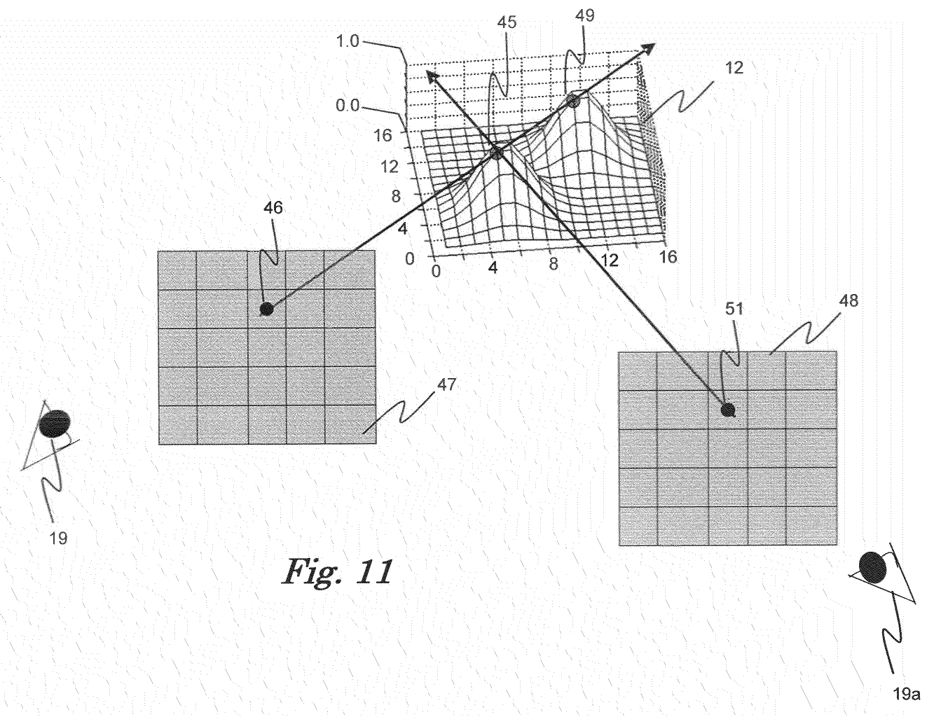

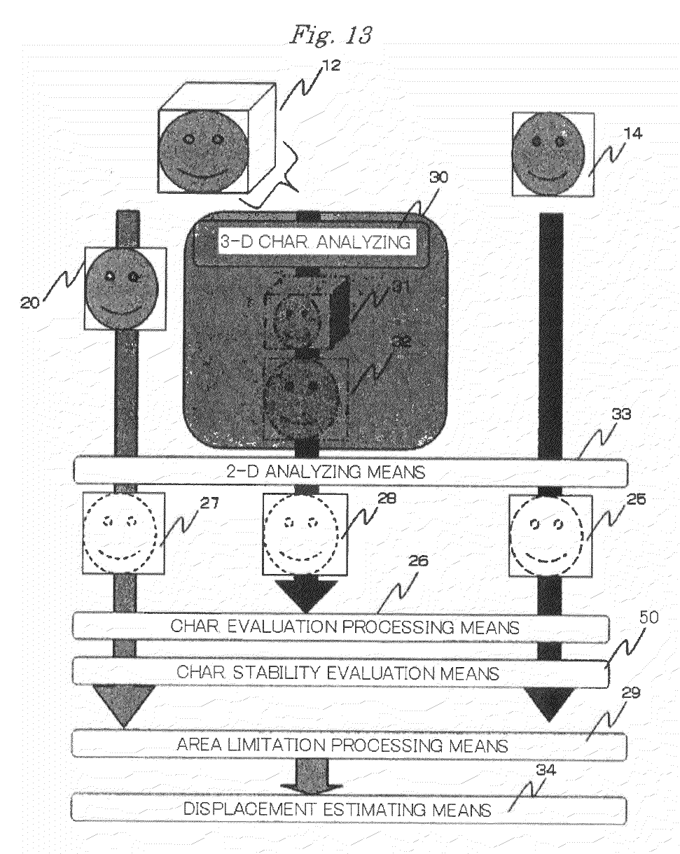

In this embodiment, as shown in a process flowchart of FIG. 13, a characteristic stability evaluation means 50 is added between the characteristic evaluation processing means 26 and the area limitation processing means 29 in Embodiment 1. This characteristic stability evaluation means 50 can process to solve a problem of preservability of characteristic points during mapping from the CT data 12 onto the DRR image 20 in the characteristic evaluation processing means 26. For example, as shown in FIG. 11, when mapping onto a DPR image 47 along a certain direction from a point of view using a ray casting algorithm, if two three-dimensional characteristic points 45 and 49 which are obtained by three-dimensional characteristic analyzing are overlapped, and then a two-dimensional characteristic point 46 will be preserved as an overlapping characteristic point. But when mapping along another direction from the point of view 19a for generating a DPR image 48, the DPR image 48 including a good two-dimensional characteristic point 51 can be obtained.

Incidentally, FIG. 11 shows a simplified relation, but in practice, it will be a complicated process to map 3-D data onto 2-D data using a ray casting algorithm. This problem can be solved by the characteristic stability evaluation means 50. In order to explain such a flow of process, a ray casting algorithm can be formulated in a simple manner as follows. I(x, y) in equation (1) denotes a value of a pixel located on coordinate axes (x, y) of the DPR image 20. R(X, Y, Z) denotes a CT value of coordinates (X, Y, Z) obtained from the CT data 12 or interpolated between the CT data 12. Therefore, the equation (1) demonstrates that I(x, y) can be defined as summation of the CT data along the direction from the point of view 19, wherein α is transmissivity.

$$I ( x , y ) = {R}_{0} ( X , Y , Z ) + {R}_{1} ( X , Y , Z ) ( 1 - {α}_{0} ) + {R}_{2} ( X , Y , Z ) ( 1 - {α}_{0} ) ( 1 - {α}_{1} ) + … + {R}_{n} {\prod }_{j = 1}^{n} ( 1 - {α}_{j} ) \qquad ( 1 )$$

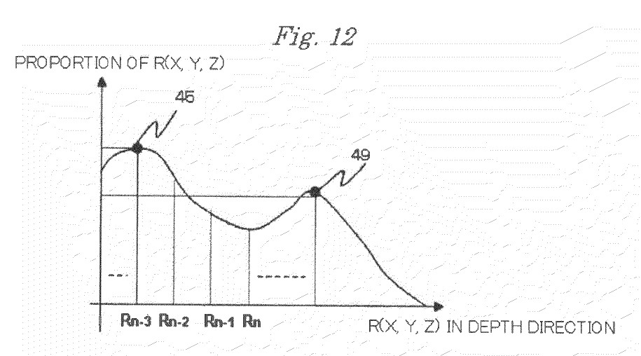

Next, for I(x, y) calculated by the equation (1), we will evaluate proportions of additive terms in the right-hand side of the equation (1). A example of value R of the DPR image 47 in FIG. 11 is shown in FIG. 12, wherein horizontal axis thereof expresses a distance from a point of view. Vertical axis expresses a normalized value of the value R in the equation (1). Therefore, the additive terms in the right-hand side of the equation (1) correspond to elements of the horizontal axis. This processing equates with as expressed using histogram or stochastic model, and it may be expressed using histogram or stochastic model. For evaluation, if the normalized proportion of the characteristic point 45 in FIG. 12, for example, is equal to or greater than a threshold (e.g., 80% or more), it is demonstrated to account for a large proportion for calculating I(x, y). According to this processing, characteristic points can be either selected or ignored, thereby stabilizing the characteristic points during mapping CT data (3-D data) onto a 2-D DPR image.

However, only under this evaluation, there is a possibility that I(x, y) can be largely changed by minute viewpoint conversion. Accordingly, it is envisaged to add or combine the following condition with the above evaluation. First, viewpoint conversion is performed with respect to the characteristic point 45. This corresponds to viewpoint conversion from the DPR image 47 to the DPR image 48 in FIG. 11. This conversion would be extreme, but by adding such a condition that both the pixel value of the characteristic point 46 and the pixel value of the characteristic point 51 are not changed during minute viewpoint conversion, such a characteristic point that the 3-D characteristic point 45 can be preserved under the viewpoint conversion can be extracted. This processing has the same idea as optical flow which is carried out using tracking. An alternative to the above evaluation of a small change of the pixel values is to express using a stochastic model. It is evaluated by defining, e.g., FIG. 12 as a probability density function and then analyzing mutual information with a distribution subject to minute viewpoint conversion. If the mutual information is equal to or greater than a threshold, then it is little affected by viewpoint conversion, with a small change of probability distribution as shown in FIG. 12, thereby the characteristic point 45 can be preserved. Alternatively, Gaussian distributions may be three-dimensionally added onto a characteristic point obtained by the three-dimensional characteristic analyzing means 30 with respect to the characteristic point. In this space viewpoint conversion is carried out to generate a probability density distribution of mixture Gaussian value depending on the position of point of view as shown in FIG. 12. Evaluation may be carried out on the probability density distribution. Alternatively, by using relation between 2-D Hessian matrix and 3-D Hessian matrix, a Hessian matrix between the DPR image 47 and the DPR image 46 can be calculated to evaluate a change of the eigenvalues thereof, thereby selecting stable characteristic points.

Further, it is likely that with wider spacing of characteristic points obtained by the three-dimensional characteristic analyzing means 30, the better accuracy can be obtained in registration. Hence, if the characteristic points obtained by the three-dimensional characteristic analyzing means 30 have a longer distance in-between, these are regarded as good characteristic points. Therefore, calculation of dispersion of distance between the characteristic points facilitates the evaluation. This processing can also evaluate relation of distance during mapping onto a 2-D DRR image.

Thus, any combination of the above-mentioned evaluations enables stable characteristic points to be extracted.

### Embodiment 9

In this embodiment, the above processing performed in Embodiment 8 is visually supported by the display device 5. For example, the result of FIG. 12 may be displayed in a blinking manner or with various color densities on the characteristic points 51 and 46 in the DPR images 47 and 48. Thus, characteristics obtained from the three-dimensional characteristic analyzing means 30 using viewpoint conversion as well as characteristic points for visual registration using the characteristic stability evaluation means 50 can be displayed. Consequently, by adjusting each of the thresholds in Embodiment 8, for example, each proportion can be displayed with various densities or blinking rates, so that characteristic points suitable for registration can be easily understood. Further, characteristic points unsuitable for registration, such as outlier residing in an area where no patient exists, may be automatically deleted. As a result, characteristic points suitable for registration can be selected among the characteristic points extracted by the characteristic stability evaluation means 50.

### Embodiment 10

In this embodiment, when displaying an image in Embodiment 9, anatomic information is reflected for registration. For example, such anatomic information is often known in advance based on a registration site (e.g., head and neck site, lung, liver, prostate). Therefore, anatomic information can be reflected in extraction of characteristic points to select characteristic points suitable for registration. For example, based on diagnostic imaging by a doctor or an X-ray operator, a portion of a predetermined site may be focused for registration. The area information can be analyzed using analyzing means to get anatomic information. Consequently, registration can be made in such an area to be required by a doctor.

### Embodiment 11

In Embodiments 1 to 10, the X-ray television images 14 may be registered from two- or multi-directional points of view, as shown in FIG. 4. Now, an example of two-directional processing with respect to an axis which is little dependent on the other axes will be described below using FIG. 4. In a case where X-ray television images are obtained in two orthogonal directions of X-axis and Y-axis, registration for translation and rotation with respect to Z-axis, i.e., out-of-plane axis, is difficult. In this regard, the axis of out-of-plane rotation is evaluated below. The angles of rotation about X-, Y- and Z-axes can be expressed with θ, ψ, φ, respectively. Thus, with respect to a characteristic point obtained by the three-dimensional characteristic analyzing means 30, translation and rotation about Z-axis are shifted in a minute interval. Consequently, the characteristic point 46 of the DPR image 47 may be further shifted relative to the characteristic point 51 of the DPR image 48. By selecting a characteristic point which is further shifted on this image, a stable characteristic point can be extracted. As a result, it is possible to extract a characteristic point resistant to the out-of-plane rotation.

### Embodiment 12

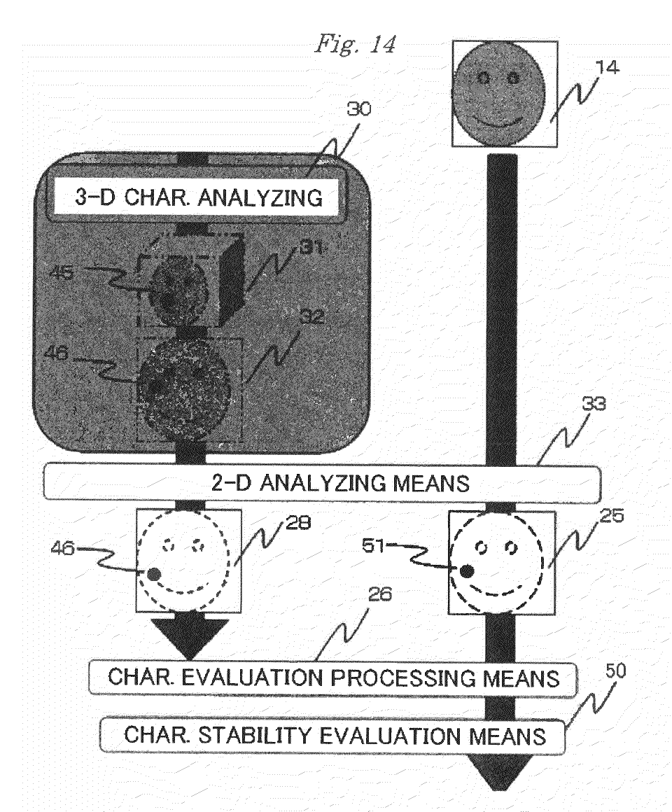

In Embodiment 12, the characteristic point obtained in Embodiments 8 and 9 will be processed as below without the displacement estimation means 34. Registration is carried out using six or more stablest characteristic points which are obtained in Embodiment 8. For example, as shown in FIG. 14, characteristic point analysis, such as SHIFT, is carried out between the X-ray television image 14 and the DPR image 21. Consequently, the characteristic points 46 and 51 which are matched with each other are obtained. Now, since the image can be expressed using affine transformation with six degrees of freedom, difference in patient registration between the X-ray television image 14 and the DPR image 21 can be uniquely calculated using six or more characteristic points. But there is no three-dimensional information between the X-ray television image 14 and the DPR image 21. In this regard, a plurality of characteristic points which are stable between the DPR image 21 and the CT data 12 are selected in advance among characteristic points obtained in Embodiment 8. Consequently, the resultant characteristic point 46 is equivalent to has three-dimensional information of the characteristic point 45. With this characteristic point 45, each amount of displacement during registration of patient with six degrees of freedom is calculated using characteristic points which are matched between the X-ray television image 14 and the DPR image 21 as noted above. According to the above processing, estimation of registration can be uniquely carried out without optimal calculation in the displacement estimation means 34, resulting in reduced time of calculation. Further, registration may be also carried out in combination with the displacement estimation means 34, resulting in highly accurate estimation of registration.

### Embodiment 13

In this embodiment, proportion of reliability on characteristic points 45 and 46 used in Embodiment 12 is statistically processed to store it as data. For example, during registration of patient based on a certain site, area and proportion of preservability for characteristic points obtained in Embodiments 8 and 9 are stored as data. This processing can be applied to statistical processing for a plurality of patients. Consequently, characteristic points and area for suitable registration of patient, registration accuracy, etc, can be stored as prior information, which will be reflected during subsequent registration of patient. For example, these can be appended as registration date to data for planning of treatment, and relation of characteristic points and area are modeled as probability distribution model using past history, and a result of frequency in use of the past history for characteristic points used for display or registration as well as registration accuracy may be displayed with various blinking rates or densities. Further, these data may be used for evaluation of extracting characteristic points for automatic registration. According to this processing, reliability on characteristic points obtained in Embodiments 8 and 9 can be statistically evaluated, so that characteristic points for not only a particular patient but also a general model can be obtained, resulting in reliability of registration accuracy.

In the embodiments described above, it is preferable to carry out parallel computation using a GPU (Graphic Processing Unit), thereby achieving high speed processing.

Although the present invention has been fully described in connection with the preferred embodiments thereof and the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A patient registration system comprising:
a CT data capturing device for capturing three-dimensional CT data of a diseased site;
an X-ray television imaging device for capturing an X-ray television image of the diseased site; and
an image processing device for generating a two-dimensional DRR image based on the captured CT data, and then calculating an amount of displacement between a first diseased site position when the CT data is captured and a second diseased site position when the X-ray television image is captured, based on the generated DRR image and the captured X-ray television image;
wherein the image processing device carries out processes of:
three-dimensional analysis for extracting an amount of three-dimensional characteristic from the three-dimensional CT data;
two-dimensional analysis for extracting an amount of two-dimensional characteristic from both of the DRR image and the X-ray television image;
characteristic evaluation for evaluating the extracted characteristic amounts;
area limitation for selecting an area where the evaluated characteristic amounts are present; and
displacement estimation for estimating an amount of displacement between the first diseased site position and the second diseased site position within the selected area.

2. The patient registration system according to claim 1, wherein the image processing device carries out data compression of the captured three-dimensional CT data to convert them into low resolution three-dimensional CT data.

3. A patient registration system comprising:
a CT data capturing device for capturing three-dimensional CT data of a diseased site;
an X-ray television imaging device for capturing an X-ray television image of the diseased site; and
an image processing device for generating a two-dimensional DRR image based on the captured CT data, and then calculating an amount of displacement between a first diseased site position when the CT data is captured and a second diseased site position when the X-ray television image is captured, based on the generated DRR image and the captured X-ray television image;
wherein the image processing device carries out processes of:
two-dimensional analysis for extracting an amount of two-dimensional characteristic from both of the DRR image and the X-ray television image;
characteristic evaluation for evaluating the extracted characteristic amounts;
area limitation for selecting an area where the evaluated characteristic amounts are present; and
displacement estimation for estimating an amount of displacement between the first diseased site position and the second diseased site position within the selected area; and
optimum parameter estimation for estimating an optimum parameter by varying a parameter of out-of-plane rotation after the displacement estimation.

4. The patient registration system according to claim 1, wherein the image processing device carries out a process of optimum parameter estimation for estimating an optimum parameter by varying a parameter of out-of-plane rotation after the displacement estimation.

5. The patient registration system according to claim 4, wherein, when estimating an optimum parameter by varying a parameter of out-of-plane rotation, the image processing device evaluates whether or not the characteristic point disappears.

6. The patient registration system according to claim 1, wherein in the displacement estimation, the image processing device firstly estimates the amount of displacement of the area that is distant from the isocenter when the X-ray television image is captured, and then estimates the amount of displacement of the area that is closer to the isocenter.

7. The patient registration system according to claim 1, wherein in the two-dimensional analysis, the processing is carried out by limiting only to the CT data having brightness values within a predetermined range.

8. The patient registration system according to claim 1, wherein the image processing device evaluates preservability expressing a possibility that a characteristic point in the three-dimensional CT data can be preserved in the two-dimensional DRR image to generate a projected image, and then extracts a characteristic point which has preservability or is matched between the projected image of an area and the X-ray television image to carry out three-dimensional registration based on the extracted characteristic point.

9. The patient registration system according to claim 8, wherein the image processing device displays the result of evaluation of preservability on the two-dimensional DRR image.

10. The patient registration system according to claim 9, wherein the image processing device extracts a characteristic point using anatomic information.

11. The patient registration system according to claim 8, wherein the image processing device extracts a characteristic point which can be largely shifted on the two-dimensional DRR image during movement of coordinates.

12. A patient registration system comprising:
a CT data capturing device for capturing three-dimensional CT data of a diseased site;
an X-ray television imaging device for capturing an X-ray television image of the diseased site; and
an image processing device for generating a two-dimensional DRR image based on the captured CT data, and then calculating an amount of displacement between a first diseased site position when the CT data is captured and a second diseased site position when the X-ray television image is captured, based on the generated DRR image and the captured X-ray television image;
wherein the image processing device carries out processes of:
three-dimensional analysis for extracting an amount of three-dimensional characteristic from the three-dimensional CT data;
two-dimensional analysis for extracting an amount of two-dimensional characteristic from both of the DRR image and the X-ray television image;
characteristic evaluation for evaluating the extracted characteristic amounts;
characteristic stability evaluation for evaluating preservability expressing a possibility that a characteristic point in the three-dimensional CT data can be preserved in the two-dimensional DRR image; and
displacement estimation for estimating an amount of displacement between the first diseased site position and the second diseased site position based on the plural characteristic points having preservability.

13. The patient registration system according to claim 8, wherein the image processing device applies statistical processing to the result of patient registration to store them as treatment plan data.

14. The patient registration system according to claim 12, wherein the image processing device applies statistical processing to the result of patient registration to store them as treatment plan data.
